(19) United States
(12) Patent Application Publication
(10) Pub. No.: US 2011/0125874 A1
(43) Pub. Date: May 26, 2011

(54) SYSTEM AND METHOD FOR TRANSMITTING MULTIMEDIA CONTENT

(75) Inventor: Jong Geun PARK, Daejeon (KR)

(73) Assignee: Electronics and Telecommunications Research Institute, Daejeon (KR)

(21) Appl. No.: 12/876,550

(22) Filed: Sep. 7, 2010

(30) Foreign Application Priority Data
Nov. 24, 2009 (KR) 10-2009-0113744

(51) Int. Cl. G06F 15/16

(52) U.S. Cl. 709/219; 709/217

(57) ABSTRACT

Disclosed are a multimedia content transmission system and a method thereof. The multimedia content transmission system and the method thereof includes generating profile information about a user of a terminal in response to a transmission request for a multimedia content being inputted from the terminal, dividing the multimedia content corresponding to the transmission request into a plurality of media contents based on the profile information, and transmitting, to a corresponding virtual terminal of at least one virtual terminal related to the user, each of the media contents via a corresponding individual transmission network, in response to the transmission request.

### CROSS-REFERENCE TO RELATED APPLICATION

This application claims the benefit of Korean Patent Application No. 10-2009-0113744, filed on Nov. 24, 2009, in the Korean Intellectual Property Office, the disclosure of which is incorporated herein by reference.

### BACKGROUND

1. Field

The present invention relates to a multimedia content transmission system and a method thereof.

2. Description of Related Art

In a current network service utilization environment, a user may access a public network or a private network via one or more wired or wireless connection interfaces that are embedded or are externally connected to a terminal, by using a fixed or a mobile terminal that is owned or rented by the user, and the user may be authenticated by a network service provider to receive a service.

In general, the terminal used for receiving a network service is a single device, includes at least one network access interface that is capable of accessing a network using schemes such as Ethernet, Wi-Fi, various Digital Subscriber Line technologies (xDSL), code division multiple access (CDMA), wideband code division multiple access (W-CDMA), Global System for Mobile Communications (GSM), High-Speed Downlink Packet Access (HSDPA), Cable Television (CATV), and the like, and continuously receives the network service via the at least one network access interface.

A technology that guarantees a mobility in a same user access network to guarantee a continuity of a service even when a user changes locations, such as a handover in a mobile communication service, has already been commercialized. In addition, a technology where a terminal includes one or more network access interfaces to guarantee a mobility between two different access networks has been developed.

However, in a multimedia content transmission service via a conventional network, a user requests an access to the service by using a single terminal, such as a mobile phone, a desktop PC, a notebook, a personal digital assistant (PDA), an ultra mobile personal computer (UMPC), and the like, the single terminal having a network interface that enables the user to access the public network, and the user receives the multimedia content through a network connection service after an authentication process and a service negotiation process.

In this instance, when the user does not have a suitable terminal that is capable of replaying a specific multimedia content, the service may not be provided.

Accordingly, a future network environment is being developed to provide a multimedia content to the user via various routes by constructing a virtual network terminal where one or more terminal devices act as a single terminal device, as opposed to being a network environment that uses a network service based on a single terminal device. Each terminal device, namely, a virtual terminal constituting the virtual network terminal format, may be used for providing a unique network service.

Thus, there is a desire for a technique that divides the multimedia content that is provided via a network in a virtual network terminal environment into individual streams constituting the multimedia content based on a format of each terminal constituting the virtual network terminal and a network interface, and transmits the individual streams to corresponding terminals, as opposed to a technology that transmits the multimedia content as a single stream of content.

### SUMMARY

An aspect of the present invention provides a multimedia content transmission system and method that may dynamically divide and convert a multimedia content based on characteristics of various terminals that replay the multimedia content to transmit as streams of different transmission networks, thereby effectively using a terminal of a user and a network resource when a multimedia content service is performed.

Another aspect of the present invention also provides a multimedia content transmission system and method that may divide a multimedia content into a plurality of media contents based on characteristics or status of various terminals around the user, may convert formats of the plurality of media contents, and may transmit the converted media contents, thereby enabling the user to receive a multimedia service having an optimal service quality without regards to a time and a location, when the multimedia content is provided to the user in a ubiquitous computing environment.

Another aspect of the present invention also provides a multimedia content transmission system and method that may dynamically provide a customized content even where a terminal to be used by a user is changed due to a change of a location of the user or a change of a service utilization environment, thereby enabling continuous service.

According to an aspect, there is provided a system of transmitting a multimedia content, the system including a content controlling unit to generate profile information about a user of a terminal in response to a transmission request for a multimedia content being inputted from the terminal, a content dividing unit to divide the multimedia content corresponding to the transmission request into a plurality of media contents based on the profile information, and a content transmitting unit to transmit, to a corresponding virtual terminal of at least one virtual terminal related to the user, each of the media contents via a corresponding individual transmission network, in response to the transmission request.

According to still another aspect, there is provided a method of transmitting multimedia contents, the method including receiving, from a content server, a multimedia content corresponding to a transmission request from a terminal, dividing the received multimedia content into a plurality of media contents based on profile information about a user of the terminal, and transmitting, to a corresponding virtual terminal of at least one virtual terminal related to the user, each of the media contents via a corresponding individual transmission network, in response to the transmission request.

Additional aspects, features, and/or advantages of embodiments will be set forth in part in the description which follows and, in part, will be apparent from the description, or may be learned by practice of the disclosure.

### EFFECT

According to an embodiment of the present invention, an effective user of a terminal of a user and a network resource is enabled and a quality of service is guaranteed.

According to an embodiment of the present invention, a multimedia service having an optimal service quality is provided to a user without regards to a time and a location.

According to an embodiment of the present invention, a customized content is dynamically provided even where a terminal to be used by a user is changed due to a change of a location of the user or a change of a service environment around the user.

According to an embodiment of the present invention, a service providing various multimedia contents is realized while a quality of service is guaranteed, without limitation of a property of a terminal owned by a user.

According to an embodiment of the present invention, a user selectively determines a type of a service most suitable for the user among various service qualities and charging policies and receives a service, while a variety of network-access networks are provided based on different transmission qualities and charging policies.

According to an embodiment of the present invention, a user receives a service by selecting a best charging policy suitable for a desired quality, and a service provider constructs various services to provide to many users, thereby expecting an effect of making a profit by development of a new service and stimulation of a desire for the service.

### BRIEF DESCRIPTION OF THE DRAWINGS

These and/or other aspects and advantages will become apparent and more readily appreciated from the following description of the embodiments, taken in conjunction with the accompanying drawings of which:

FIG. 1 is a block diagram illustrating an internal format of a multimedia content transmission system according to an embodiment of the present invention;

FIG. 2 is a diagram illustrating a process where a multimedia content is divided and transmitted, when a content server and a user are remotely connected according to an embodiment of the present invention;

FIG. 3 is a diagram illustrating a process where a multimedia content is divided and transmitted when a contents server and a user are in a same private network; and

FIG. 4 is a flowchart illustrating a multimedia content transmission method according to an embodiment of the present invention.

### DETAILED DESCRIPTION

Reference will now be made in detail to embodiments, examples of which are illustrated in the accompanying drawings, wherein like reference numerals refer to the like elements throughout. Embodiments are described below to explain the present disclosure by referring to the figures

An embodiment of the present invention considers an environment where a user is provided with a desired service by using a user's own private terminal or by sharing or renting a public terminal among many available around the user and intellectualized in a ubiquitous computing environment.

In this instance, the user's own private terminal and the rented public terminal may be provided with a network service by containing one or more different network interfaces or connecting with an external device, and different network service fee charging policies may be applied based on a subscriber's network that provides an access service. As an example, different charging policies may be applied to a wired local area network (LAN) service, a wireless LAN service, an High-Speed Downlink Packet Access (HSDPA) service, a WiBro service, a satellite communication service, and the like based on a service operator.

That is, according to an embodiment of the present invention, the multimedia content is appropriately unified or divided based on various variables, such as a network interface device of each of a plurality of terminals, a service fee charging policy, a function of each terminal, an ownership of the terminal, and the like, thereby increasing a use of a network resource, and increasing user satisfaction in a quality of service and a service charge.

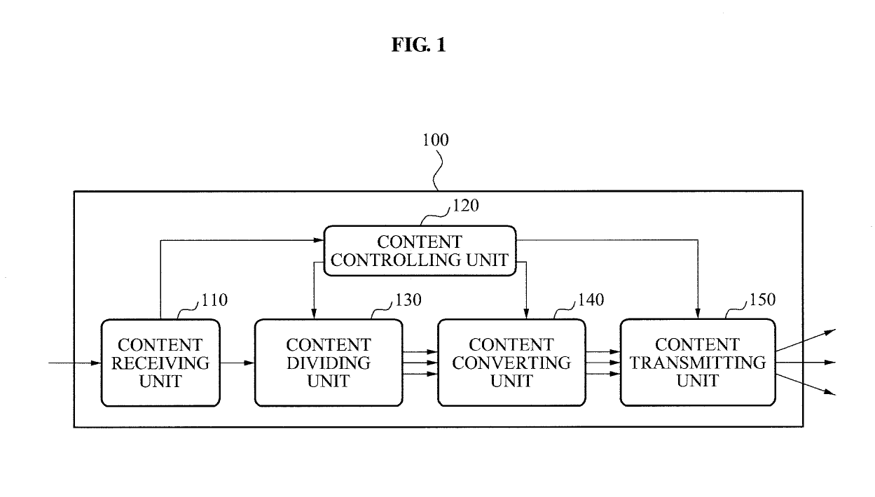

FIG. 1 is a block diagram illustrating an internal format of a multimedia content transmission system 100 according to an embodiment of the present invention.

The multimedia content transmission system 100 of FIG. 1 may be a unified system or may be manufactured as separate units to be independently combined.

The multimedia content transmission system 100 may include a content receiving unit 110, a content controlling unit 120, a content dividing unit 130, a content converting unit 140, and a content transmitting unit 150.

When a transmission request for a multimedia content is inputted, the content receiving unit 110 may receive a multimedia content corresponding to the transmission request from a content server.

The content server may be one of a content producing device, a content storage device, and an external system.

In this instance, the contents receiving unit 110 may receive a control request for controlling division or conversion of the multimedia contents. The control request may be generated based on a user's utilization environment characteristics of the multimedia content and may be received by the content receiving unit 110. Alternatively, the control request may be inputted to the content controlling unit 120 via another route.

The content controlling unit 120 may generate profile information about a user of a terminal, after the transmission request for the multimedia content is inputted from the terminal.

The profile information may include information about at least one virtual terminal connected with the terminal via a virtual network. As an example, the profile information may include a type of the at least one virtual terminal, address information of the at least one virtual terminal, network interface information about the at least one virtual terminal, a type of transmission network, charging information, and the like. Also, the profile information may include service environment information about the user's preference in using a service.

The at least one virtual terminal may be spaced away from the terminal within a predetermined distance and may construct the virtual network with the terminal. That is, the at least one virtual terminal may be all terminals located around the user.

The contents controlling unit 120 may control the division and conversion of the multimedia content based on one of contents source, at least one virtual terminal of a content user, and content service utilization environment information.

Also, preferentially, the content controlling unit 120 may generate the profile information based on one of an attribution of the multimedia content, service quality information, and charging information.

In other words, the content controlling unit 120 may combine at least one virtual terminal provide a customized at least one virtual terminal in response to a service quality request based on an attribution of a multimedia content to be provided, a service quality, a price, and the like, and may provide an optimal service by actively determining the profile information.

The content controlling unit 120 may update the generated profile information in response to a change in a location of the user or a change of the at least one virtual terminal.

Accordingly, although a service environment is diversely changed due to the change in the location of the user or a change of a terminal device constituting the virtual terminal, the content controlling unit 120 may continuously provide multimedia content service based on the updated profile information.

The content dividing unit 130 may divide the multimedia content corresponding to the transmission request into a plurality of media contents based on the profile information.

As an example, the content dividing unit 130 may identify at least one virtual terminal based on the profile information, and may divide the multimedia content into the plurality of media contents based on a number of the identified at least one virtual terminal.

The content dividing unit 130 may divide the multimedia content into two or more media contents or two or more media sources based on the profiled information inputted from the content controlling unit 120.

As an example, the content dividing unit 130 may divide a moving picture multimedia content into an image media content, a voice media content, a text media content such as a capture, an advertisement media content, a synchronization signal, and the like, or may divide the moving picture multimedia content into two or more media groups.

In this instance, a standard for dividing the content may be a service utilization environment characteristic of the user. As an example, it is assumed that the at least one virtual terminal used by the user includes an image monitor where a wired LAN device is installed, a radio device where an FM wireless receiver is installed, and a mobile phone where an HSDPA device is installed. The content dividing unit 130 may divide the moving picture multimedia content to be provided into an image media content, a voice media content, and other media contents, based on the at least one virtual terminal related to the user, such as the image monitor, the radio device, and the mobile phone. Accordingly, the user may view the image media content through the image monitor around the user, may listen to the voice media content through the radio device where the FM wireless receiver is installed, and may receive, through the mobile phone, the other media contents having a small amount of data being transmitted, such as control information about synchronization of each media content. In this instance, the user may reduce a burden of a charge caused by a large amount of data being transmitted compared with a charge incurred when receiving the moving picture multimedia content as is through the mobile phone of the user.

The content transmission unit 150 may transmit the media contents to the at least one virtual terminal related to the user, respectively, via corresponding individual transmission networks in response to the transmission request.

In other words, the content transmitting unit 150 may transmit each of the media contents via a corresponding individual transmission network recognized based on network interface information related to the identified at least one virtual terminal.

In this instance, the content converting unit 140 may convert each of the media contents into a format that is applicable to a corresponding virtual terminal. In other words, the content converting unit 140 may convert each of the divided media contents to be optimally replayed in a corresponding virtual terminal based on the profile information. The content transmitting unit 150 may distinctively transmit individual media contents divided by the content dividing unit 130 and converted by the content converting unit 140, via corresponding transmission networks based on network interface information, the contents dividing unit 130 and the contents converting unit 140 being controlled by the content controlling unit 120.

Also, the content transmitting unit 150 may transmit control information about synchronization of the media contents to the at least one virtual terminal.

In other words, the content transmitting unit 150 may transmit the media contents together with the control information over one or more network-access networks, thereby enabling the transmitted plurality of media contents to be synchronized with each other. Accordingly, when each of the media contents is replayed in a corresponding virtual terminal, the media contents may be replayed as though a single multimedia content is transmitted via a single network-access network.

The content controlling unit 120 may store authentication information of the user with respect to a corresponding individual transmission network or authentication information of the at least one virtual terminal with respect to a corresponding individual transmission network. The content transmitting unit 150 may check an authority for the corresponding individual transmission network by extracting the authentication information from a database when the media contents are transmitted.

The content controlling unit 120 may check the authentication information of the user with respect to the corresponding individual transmission network or the authentication information of the at least one virtual terminal with respect to the corresponding individual transmission network, thereby enabling the contents transmitting unit 150 to select an available transmission network as necessary and to transmit each of the divided media contents.

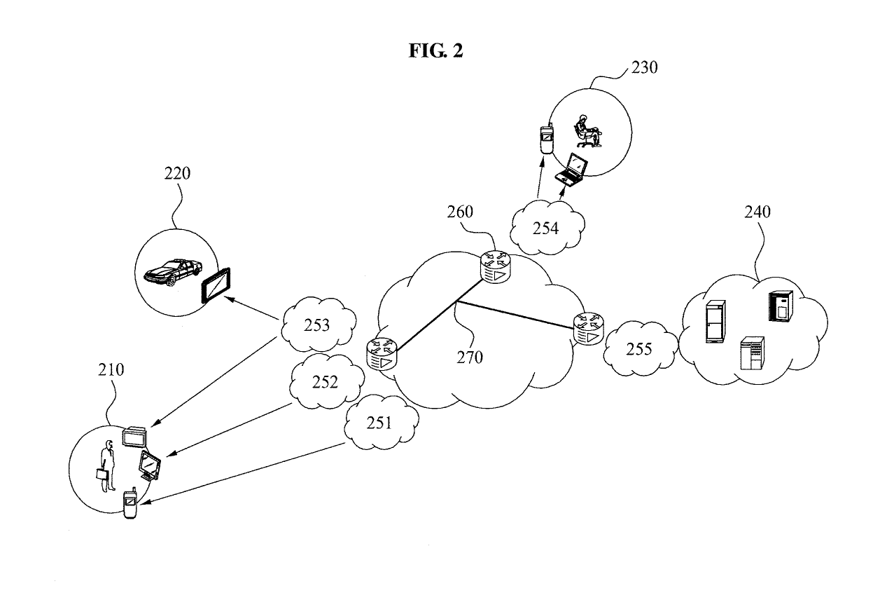

FIG. 2 is a diagram illustrating a process where a multimedia content is divided and transmitted, when a content server and a user are remotely connected, according to an embodiment of the present invention.

A multimedia content transmission system 260 may provide multimedia content received from a remote content server 240 via at least one virtual terminal 210, at least one virtual terminal 220, and at least one virtual terminal 230 that are provided to a user A, a user B, and a user C, respectively.

In this instance, a scheme of connection between users A, B, and C and the remote content server 240 may be different from each other, based on characteristics of the at least one virtual terminal 210, at least one virtual terminal 220, and at least one virtual terminal 230 provided to the users A, B, and C. As an example, in a case of the at least one virtual terminal 210 of the user A, the at least one virtual terminal 210 being constituted by terminal devices having three different network access interfaces, the multimedia content transmission system 260 may divide the received multimedia content and may transmit the media contents via different three access communication networks 251, 252, and 253.

In other words, although the multimedia content is a single multimedia content, the multimedia content transmission system 260 may divide the multimedia content into media contents based on a characteristic of the at least one virtual terminal used by the user and a characteristic of a network access interface, and may transmit the media contents over two or more different access communication networks 251, 252, 253, 254, and 255. Also, the multimedia content transmission system 260 may also transmit control information to enable each of the media contents to be synchronized.

In this instance, embodiments are not limited to always performing transmission of each of the media contents via different access communication networks.

The user may continuously move, and the at least one virtual terminal 210, the at least one virtual terminal 220, and the at least one virtual terminal 230 provided to the users may be continuously changed, and thus, the multimedia content transmission system 260 may divide the multimedia contents into media contents to transmit as media contents or may transmit the multimedia contents as a unified content, based on a characteristic of the at least one virtual terminal used by the user.

As an example, when the at least one virtual terminal 230 provided to the user C is constituted by terminal devices, such as a mobile phone and a notebook, the multimedia content transmission system 260 may transmit each of the media contents to a corresponding terminal device, and when the at least one virtual terminal 230 provided to the user B is constituted by a navigation device, the multimedia content transmission system 260 may unify and transmit the media contents as a single unified content.

In the same manner, in a ubiquitous computing environment, the multimedia content transmission system 260 may divide the multimedia content into media contents based on a user environment and a user's preference in using the service, as opposed to being based on a service providing policy or a service characteristic, and may transmit the media contents via different access communication networks 251, 252, 253, 254, and 255.

For reference, the multimedia content transmission system 260 may exist in an end of a core network 270, may exist in an end of an access networks 251, 252, 253, 254, and 255, or may be included in the remote content server 240 of which a location is not limited.

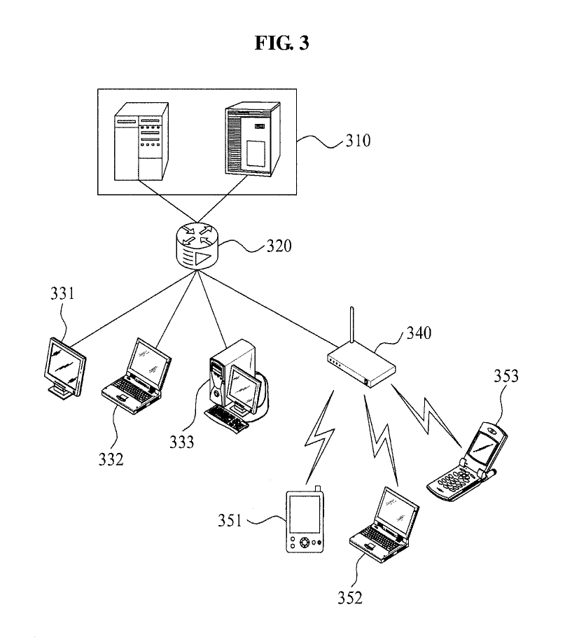

FIG. 3 illustrates a process where a multimedia contents is divided and transmitted when a contents server and a user are in a same private network

The multimedia content transmission system 100 of FIG. 1 may be included in a content server 310 or a network relay device 320 or may be arranged as separate systems connected with the network relay device 320.

As illustrated in FIG. 3, the content server 310 may be connected with each of virtual terminals 331, 332, 333, 351, 352, and 353 via the network relay device 320, such as a switch and a router, and the virtual terminals 351, 352, and 353 having wireless network interfaces may be connected via a wireless network access device 340 such as a wireless LAN access point.

In this instance, in an ubiquitous computing environment, a single private network of FIG. 3 may receive a single network service by using a plurality of virtual terminals 331, 332, 333, 351, 352, and 353 based on user's environment, and when the virtual terminals 331, 332, 333, 351, 352, and 353 have different network access interfaces with each other, the multimedia content transmission system 100 may divide the multimedia content into a plurality of media contents and may transmit each of the media contents based on a user terminal characteristic.

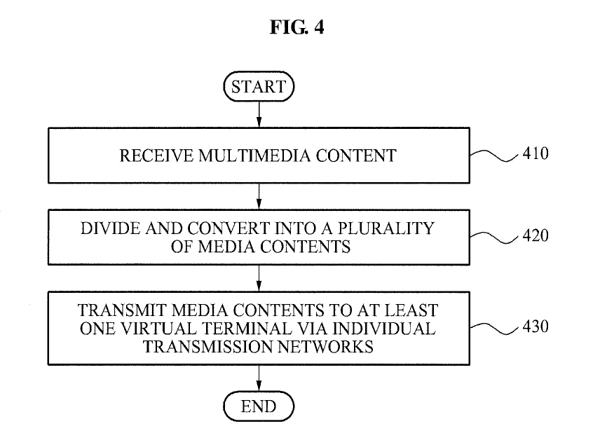

FIG. 4 is a flowchart illustrating a multimedia content transmission method according to an embodiment of the present invention.

The multimedia content transmission method according to an embodiment of the present invention may be embodied by the multimedia content transmission system 100 of FIG. 1. Hereinafter, FIG. 4 will be described with reference to the description of FIG. 1.

In operation 410, the multimedia content transmission system 100 receives, from a content server, a multimedia content corresponding to a transmission request from a terminal.

The content receiving unit 110 may receive the multimedia content corresponding to the transmission request, from the content server, in response to the transmission request for the multimedia content being inputted from the terminal.

Here, the content server may be one of a content producing device, a content storage device, and an external system.

The content receiving unit 110 may receive a control request for controlling of division or conversion of the multimedia content. The control request may be generated based on a user's utilization environment characteristic of the multimedia content and may be received by the content receiving unit 110. Alternatively, the control request may be inputted to the content controlling unit 120 via another route.

In operation 420, the multimedia content transmission system 100 may divide the received multimedia content into a plurality of media contents based on profile information about the user of the terminal.

The profile information may include information about at least one virtual terminal connected with the terminal via a virtual network. As an example, a type of virtual terminal, address information of the at least one virtual terminal, a network interface about the at least one virtual terminal, a type of transmission network, charge information, and the like. Also, the profile information may include service environment information about a user's preference in using a service.

The at least one virtual terminal may be spaced away from the terminal within a predetermined distance to construct the virtual network with the terminal. That is, the at least one virtual terminal may be all terminals around the user.

As an example, the content dividing unit 130 may identify the at least one terminal based on the profile information, and may divide the multimedia content into the plurality of media contents based on a number of the at least one virtual terminal. Also, the content dividing unit 130 may divide the multimedia content into the plurality of media contents based on a number of network interface devices included in the identified at least one virtual terminal.

The content dividing unit 130 may divide a single multimedia content into two or more media contents or two or more media sources based on the profile information inputted from the content controlling unit 120.

As an example, the content dividing unit 130 may divide a moving picture multimedia content into an image media content, a voice media content, a text media content such as a caption, an advertisement media content, a synchronization signal, and the like, or may divide the moving picture multimedia content into two or more media groups.

In this instance, a standard for dividing the content may be a service utilization environment characteristic of the user. As an example, it is assumed that the at least one virtual terminal used by the user includes an image monitor where a wired LAN device is installed, a radio device where an FM wireless receiver is installed, and a mobile phone where an HSDPA device is installed. The content dividing unit 130 may divide the moving picture multimedia content to be provided into an image media content, a voice media content, and other media contents, based on the at least one virtual terminal related to the user, such as the image monitor, the radio device, and the mobile phone. Accordingly, the user may view the image media content through the image monitor around the user, may listen the voice media content through the radio device where the FM wireless receiver is installed, and may receive, through the mobile phone, the other media contents having a small amount of data being transmitted, such as control information about synchronization of each media content. In this instance, the user may reduce a burden of a charge caused by a large amount of data being transmitted compared with a charge incurred when receiving the moving picture multimedia content as is through the mobile phone of the user.

In this instance, the content converting unit 140 may convert each of the media contents into a format that is applicable to a corresponding virtual terminal. In other words, the content converting unit 140 may convert each of the media contents to be optimally replayed in a corresponding virtual terminal based on the profile information including hardware characteristic of the corresponding virtual terminal.

In operation 430, the multimedia content transmission system 100 may transmit the plurality of media contents to the at least one virtual terminal related to the user, respectively, via corresponding individual transmission networks in response to the transmission request.

In other words, the content transmitting unit 150 may perform transmission of each of the plurality of media contents via a corresponding individual transmission network recognized based on network interface information about the identified at least one virtual terminal.

The content transmitting unit 150 may transmit the control information about synchronization of the plurality of media contents to the at least one virtual terminal.

In other words, the content transmitting unit 150 may transmit the plurality of media contents together with the control information over one or more network-access networks, thereby enabling the transmitted plurality of media contents to be synchronized with each other. Accordingly, when each of the media contents is replayed in a corresponding virtual terminal, the media contents may be replayed as though a single multimedia content is transmitted via a single network-access network.

The content controlling unit 120 may check authentication information of the user with respect to the corresponding individual transmission network or authentication information of the at least one virtual terminal with respect to the corresponding individual transmission network, thereby enabling the contents transmitting unit 150 to select an available transmission network as necessary and to transmit each of the media contents.

The method according to the above-described an embodiment of the present invention may also be implemented through computer readable code/instructions in/on a medium, e.g., a computer readable medium, to control at least one processing element to implement any above described embodiment. The medium can correspond to medium/media permitting the storing or transmission of the computer readable code.

The computer readable code can be recorded or transferred on a medium in a variety of ways, with examples of the medium including recording media, such as magnetic storage media (e.g., ROM, floppy disks, hard disks, etc.) and optical recording media (e.g., CD-ROMs, or DVDs), and transmission media. The media may also be a distributed network, so that the computer readable code is stored or transferred and executed in a distributed fashion. Still further, as only an example, the processing element could include a processor or a computer processor, and processing elements may be distributed or included in a single device.

In addition to the above described embodiments, an embodiment of the present invention can also be implemented as hardware, e.g., at least one hardware based processing unit including at least one processor capable of implementing any above described embodiment.

Although a few embodiments have been shown and described, it would be appreciated by those skilled in the art that changes may be made in these embodiments without departing from the principles and spirit of the disclosure, the scope of which is defined by the claims and their equivalents.

What is claimed is:

1. A system of transmitting a multimedia content, the system comprising:
a content controlling unit to generate profile information about a user of a terminal in response to a transmission request for a multimedia content being inputted from the terminal;
a content dividing unit to divide the multimedia content corresponding to the transmission request into a plurality of media contents based on the profile information;
a content transmitting unit to transmit, to a corresponding virtual terminal of at least one virtual terminal related to the user, each of the media contents via a corresponding individual transmission network, in response to the transmission request.

2. The system of claim 1, wherein the at least one virtual terminal is spaced away from the terminal within a predetermined distance, to construct a virtual network with the terminal.

3. The system of claim 1, wherein the content dividing unit identifies the at least one virtual terminal based on the profile information, and divides the multimedia content based on a number of the identified at least one virtual terminal.

4. The system of claim 3, wherein the content transmitting unit transmits each of the media contents via a corresponding individual transmission network that is recognized based on network interface information about the identified at least one virtual terminal.

5. The system of claim 1, further comprising:
a content converting unit to convert each of the media contents into a format that is applicable to a corresponding virtual terminal,
wherein the content transmitting unit transmits each of the converted media contents to a corresponding virtual terminal of the at least one virtual terminal.

6. The system of claim 1, wherein the content controlling unit generates the profile information including at least one of information about the at least one virtual terminal connected with the terminal via a virtual network, and service environment information about a user's preference of using a service.

7. The system of claim 1, further comprising:
a content receiving unit to receive the multimedia content corresponding to the transmission request from a content server,
wherein the content server is one of a content producing device, a content storage device, and an external system.

8. The system of claim 1, wherein the content controlling unit updates generated profile information in response to a change of a location of the user or a change of the at least one virtual terminal.

9. The system of claim 1, wherein the content transmitting unit transmits control information about synchronization of the media contents to the at least one virtual terminal.

10. The system of claim 1, wherein the content controlling unit generates the profile information based on one of an attribution of the multimedia content, service quality information, and charging information.

11. The system of claim 1, further comprising:
a database to store authentication information of the user with respect to the corresponding individual transmission network or authentication information of the at least one virtual terminal with respect to the corresponding individual transmission network,
wherein the content transmitting unit checks an authority for the corresponding individual transmission network by extracting the authentication information from the database when the each of the media contents is transmitted.

12. A method of transmitting multimedia contents, the method comprising:
receiving, from a content server, a multimedia content corresponding to a transmission request from a terminal;
dividing the received multimedia content into a plurality of media contents based on profile information about a user of the terminal; and
transmitting, to a corresponding virtual terminal of at least one virtual terminal related to the user, each of the media contents via a corresponding individual transmission network, in response to the transmission request.
